(19) United States
(12) Patent Application Publication
(10) Pub. No.: US 2016/0181657 A1
(43) Pub. Date: Jun. 23, 2016

(54) SOLID ELECTROLYTE, ALL-SOLID-STATE BATTERY INCLUDING THE SAME, AND METHOD FOR MAKING SOLID ELECTROLYTE

(71) Applicant: HITACHI, LTD., Tokyo (JP)

(72) Inventors: Jun KAWAJI, Tokyo (JP); Yusuke ASARI, Tokyo (JP); Tadashi FUJIEDA, Tokyo (JP); Hirotugu TAKIZAWA, Miyagi (JP); Yamato HAYASHI, Miyagi (JP)

(73) Assignee: HITACHI, LTD., Tokyo (JP)

(21) Appl. No.: 14/969,569

(22) Filed: Dec. 15, 2015

(30) Foreign Application Priority Data
Dec. 22, 2014 (JP) 2014-259293

(51) Int. Cl. H01M 10/0562; H01M 10/0585; H01M 10/0525

(52) U.S. Cl. CPC H01M 10/0562; H01M 10/0525; H01M 10/0585; H01M 2300/0071

(57) ABSTRACT

A solid electrolyte comprises a ramsdellite-type crystal structure and has low activation energy of lithium ions and good lithium ion conductivity. The solid electrolyte is represented by the general formula Li_{4x-2a-3b-c-2d}Sn_{4-x-c-d}M(II)ₐM(III)_{b}M(V)_{c}M(VI)_{d}O₈ [wherein M(II) is a divalent cation, M(III) is a trivalent cation, M(V) is a pentavalent cation, and M(VI) is a hexavalent cation, 0≦x≦1.33], wherein in the general formula, 0<a+b+c+d, 0≦a+b≦x, 0≦c+d<0.9, and 3x−a−2b−c−2d≦2. The all-solid-state battery includes the solid electrolyte in at least one layer of the positive electrode layer, negative electrode layer, and solid electrolyte layer. The method of making the solid electrolyte includes a step of preparing a mixed powder as a raw material and heating with microwave irradiation.

### TECHNICAL FIELD

The present invention relates to a solid electrolyte, an all-solid-state battery including the same, and a method for making a solid electrolyte.

### BACKGROUND ART

All-solid-state batteries are configured to transport carriers by an inorganic solid electrolyte. Common inorganic solid electrolytes are non-flammable or flame-retardant, so that all-solid-state batteries including an inorganic solid electrolyte are highly resistant against heat generation caused by battery reaction, and are highly safe. Therefore, all-solid-state batteries can be made into a battery module having a simplified safety mechanism for controlling temperature and others, and are suitable for the reduction of production cost and component cost. In addition, the batteries have high resistance against heat generation, so that are regarded as suitable for achieving a high energy density.

An all-solid-state battery usually includes an electrode layer containing active materials, and a solid electrolyte layer. In order to improve the performance of an all-solid-state battery, the improvement in carrier conductivity is important, so that the reduction of the interfacial resistance between the electrode layer and solid electrolyte layer, the reduction of the boundary resistance of active material particles and solid electrolyte particles, and the development of a solid electrolyte having high carrier conductivity are desired. Therefore, at present, solid electrolytes for all-solid-state lithium ion secondary batteries, such as sulfide solid electrolytes and oxide solid electrolytes are under development.

Sulfide solid electrolytes are regarded as hopeful solid electrolyte materials, because they show high lithium ion conductivity at room temperature, and can reduce interfacial resistance in the production process for producing solid electrolytes. However, sulfide solid electrolytes have problems that they have low stability in the air, and react with moisture to generate toxic or corrosive gas. On the other hand, oxide solid electrolytes have high stability in the air, but have low lithium ion conductivity.

Known oxide materials having lithium ion conductivity include lithium tin oxides having a ramsdellite-type crystal structure. For example, PTL 1 describes an active material for negative electrode for lithium battery, the active material having a ramsdellite-type structure, and being represented by Li₂₊₂ₓMg₁₋ₓSn₃O₈ (0≦x≦1). In addition, NPL 1 describes ramsdellite-type Li₂₊ₓ(LiₓMg₁₋ₓSn₃)O₈ (0≦x≦0.5) and Li₂Mg₁₋ₓFe₂ₓSn₃₋ₓO₈ (0≦x≦1).

### CITATION LIST

### Patent Literature

PTL 1: JP 10-270020 A

### Non Patent Literature

NPL 1: J. Grins and A. R. West, J. Solid State Chem., 65, p. 265-271 (1986)

### SUMMARY OF INVENTION

### Technical Problem

The ramsdellite-type oxide described in PTL 1 was made as an active material for negative electrode for lithium battery. In addition, the lithium tin oxide having a ramsdellite-type crystal structure described in NPL 1 has a conductivity of up to 5×10⁻⁴ (Ω⁻¹·cm⁻¹) and 2×10⁻⁵ (Ω⁻¹·cm⁻¹) at a temperature of 573 K, and activation energy as high as 0.74 eV. Therefore, the ramsdellite-type oxide cannot be used as a material of a solid electrolyte that is required to have high lithium ion conductivity.

Accordingly, the present invention is intended to provide a solid electrolyte having a ramsdellite-type crystal structure, an all-solid-state battery including the same, and a method for making a solid electrolyte, the solid electrolyte having a low lithium ion activation energy and high lithium ion conductivity.

### Solution to Problem

In order to solve the above-described problem, the solid electrolyte according to the present invention has a ramsdellite-type crystal structure, and is represented by a general formula Li_{4x-2a-3b-c-2d}Sn_{4-x-c-d}M(II)ₐM(III)_{b}M(V)_{c}M(VI)_{d}O₈ [wherein M(II) is a divalent cation, M(III) is a trivalent cation, M(V) is a pentavalent cation, and M(VI) is a hexavalent cation, 0≦x≦1.33], wherein in the general formula, 0<a+b+c+d, 0≦a+b≦x, 0≦c+d<0.9, and, 3x−a−2b−c−2d≦2.

In addition, in the all-solid-state battery according to the present invention, the solid electrolyte is contained in at least one layer of the positive electrode layer containing active materials for positive electrode, the negative electrode layer containing active materials for negative electrode, and the solid electrolyte layer sandwiched between the positive and negative electrode layer.

In addition, the method for making a solid electrolyte according to the present invention is a method for making a ramsdellite-type crystal structure, and is represented by a general formula Li_{4x-2a-3b-c-2d}Sn_{4-x-c-d}M(II)ₐM(III)_{b}M(V)_{c}M(VI)_{d}O₈ [wherein M(II) is a divalent cation, M(III) is a trivalent cation, M(V) is a pentavalent cation, and M(VI) is a hexavalent cation, 0≦x≦1.33], wherein in the general formula, 0<a+b+c+d, 0≦a+b≦x, 0≦c+d<0.9, and, 3x−a−2b−c−2d≦2, the method including a step of mixing an Li-containing compound, an Sn-containing compound, and a compound containing any of M(II), M(III), M(V), or M(VI) to prepare a mixed powder, and a step of firing the mixed powder by heating with microwave irradiation.

### Advantageous Effects of Invention

According to the present invention, a solid electrolyte having a ramsdellite-type crystal structure, an all-solid-state battery including the same, and a method for making a solid electrolyte are provided, the solid electrolyte having low lithium ion activation energy and a ramsdellite-type crystal structure with high lithium ion conductivity.

### BRIEF DESCRIPTION OF DRAWINGS

FIG. 1 schematically shows the crystal structure of a ramsdellite-type lithium tin oxide.

FIG. 2 schematically shows the crystal structure of a ramsdellite-type lithium tin oxide in a metastable state.

FIGS. 3(a) and 3(b) show the result of the analysis of lithium ion conductivity in the tunnel in a ramsdellite-type lithium tin oxide. FIG. 3(a) shows the state of tetrahedron coordination of lithium ions in the tunnel in a ramsdellite-type crystal structure, FIG. 3(b) shows the state of octahedron coordination of lithium ions in the tunnel in a ramsdellite-type crystal structure, and FIG. 3(c) shows the comparison of lithium ion conductivity between the tetrahedron coordination and octahedron coordination states.

FIG. 4 is a cross sectional view showing an example of the all-solid-state battery according to an embodiment of the present invention.

FIG. 5 is a cross sectional view schematically showing an example of the inter-electrode structure of the all-solid-state battery according to an embodiment of the present invention.

FIG. 6 is a cross sectional view schematically showing an example of the electrode structure of the all-solid-state battery according to an embodiment of the present invention.

### DESCRIPTION OF EMBODIMENTS

The solid electrolyte, all-solid-state battery including the same, and method for making a solid electrolyte according to embodiments of the present invention are described below in detail. The common structures through the figures are indicated with the same reference numerals, and overlapping explanation thereof is omitted.

Firstly, the solid electrolyte according to one embodiment of the present invention is described.

The solid electrolyte according to the present embodiment is an oxide solid electrolyte having a ramsdellite-type crystal structure, and is a lithium complex oxide having lithium ion conductivity. As described below, the ramsdellite-type lithium complex oxide has a tunnel structure working as a conduction path for lithium ions in the crystal structure, and shows lithium ion conductivity. The solid electrolyte according to the present embodiment is, specifically, based on a lithium tin oxide (Li₄Sn₃O₈) containing tin ions as metal ions, and has a chemical composition of the lithium tin oxide substituted with a different element.

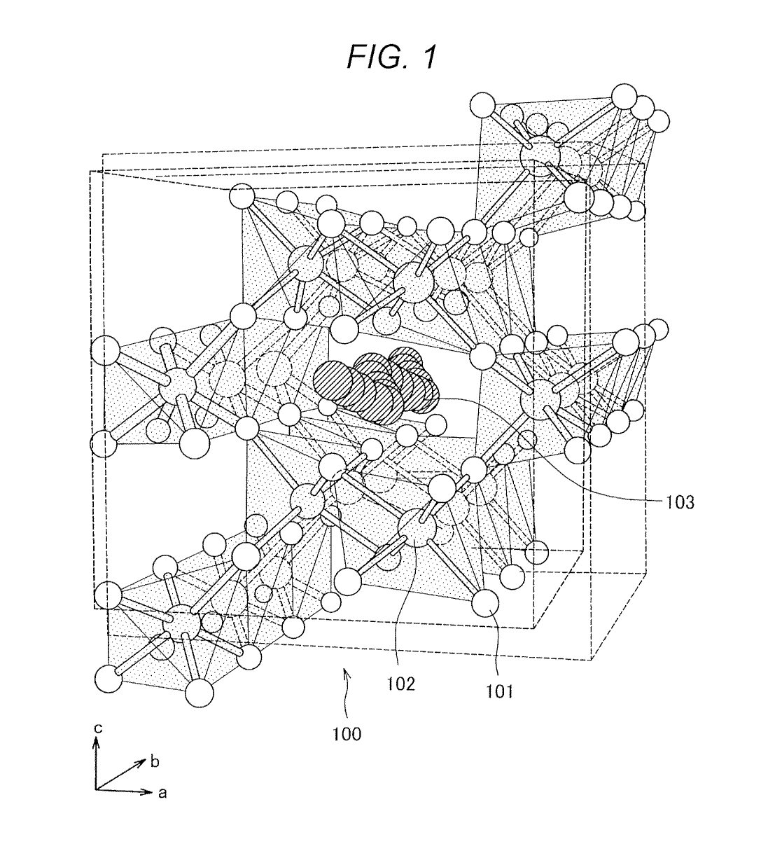

FIG. 1 schematically shows the crystal structure of a ramsdellite-type lithium tin oxide.

As shown in FIG. 1, in a ramsdellite-type lithium tin oxide 100, each of tin ions 102 is bound to six oxygen ions 101 to form an octahedron (SnO₆), and the octahedrons share edges to form two lines of chain structures, and these chain structures share the tops of both the terminals to form a steric structure. In this ramsdellite-type crystal structure, as shown in FIG. 1, a one-dimensional tunnel structure is formed in the direction of the b axis, and lithium ions 103 are present inside. FIG. 1 schematically shows a state created by an indefinite number of lithium ions 103 in the tunnel structure.

The lithium ions 103 in the tunnel structure are considered to conduct by hopping conduction. The ramsdellite-type lithium tin oxide 100 exhibits relatively good lithium ion conductivity by the conduction of the lithium ions 103 existing in this one-dimensional tunnel structure. In particular, as represented by the general formula Li₄ₓSn₄₋ₓO₈, the lithium tin oxide 100 having excessive lithium ions 103 can achieve a relatively wide potential window and a high lithium ion conductivity. Specifically, it can exhibit about 1000 times higher electric conductivity than other crystal forms with a layer structure such as Li₂SnO₃.

However, its electric conductivity is not sufficient for a solid electrolyte material, so that higher lithium ion conductivity is demanded.

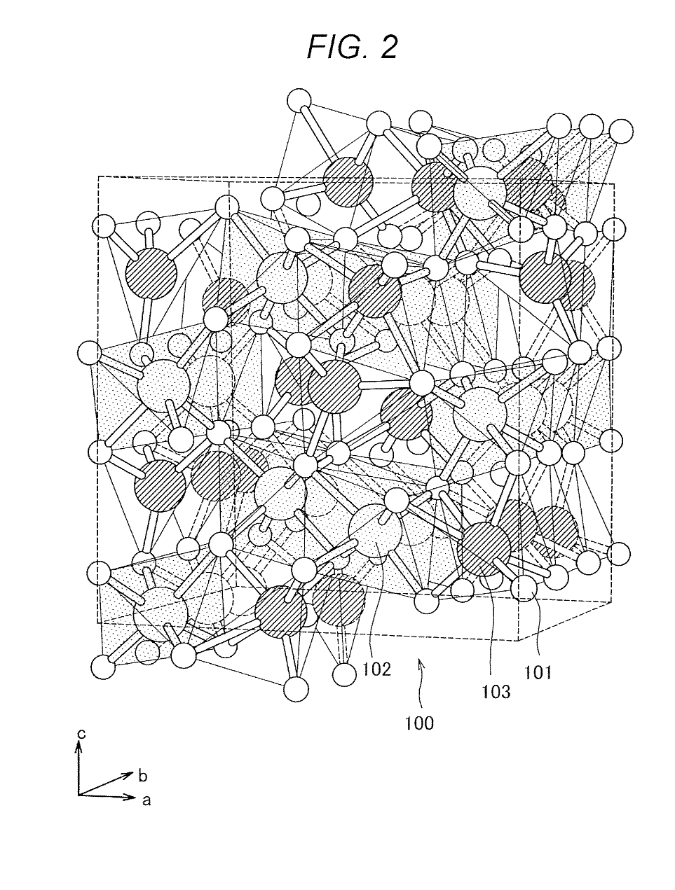

FIG. 2 schematically shows the crystal structure of a ramsdellite-type lithium tin oxide in a metastable state.

As shown in FIG. 2, in the ramsdellite-type lithium tin oxide 100, the lithium ions 103 are stably bound in the tunnel structure. More specifically, the number of lithium ions 103 in a metastable state that can exist in the tunnel structure is limited. In addition, the proportion of the lithium ions 103 that can be substituted by tin sites in the octahedron (SnO₆) is limited to the range wherein the ramsdellite-type crystal structure is stably maintained. Specifically, the chemical composition that can stably maintain the ramsdellite-type crystal structure is represented by the general formula Li₄ₓSn₄₋ₓO₈, wherein x is limited to a range of 0≦x≦1.33. Therefore, as represented by the general formula Li₄ₓSn₄₋ₓO₈, lithium ion conductivity peaks out in the lithium tin oxide 100 having excessive lithium ions 103, so that sufficient lithium ion conductivity suitable for a solid electrolyte material is hard to achieve.

Therefore, the solid electrolyte according to the present embodiment is based on the lithium tin oxide (Li₄ₓSn₄₋ₓO₈), and the lithium ions 103 and tin ion 102 forming a ramsdellite-type crystal structure are substituted with a different element using other polyvalent cation, thereby making a structure having low activation energy for lithium ion conduction through a one-dimensional tunnel structure, while stably maintaining the crystal structure by charge compensation.

Specifically, the solid electrolyte according to the present embodiment is represented by the general formula Li_{4x-2a-3b-c-2d}Sn_{4-x-c-d}M(II)ₐM(III)_{b}M(V)_{c}M(VI)_{d}O₈ [wherein M(II) is a divalent cation, M(III) is a trivalent cation, M(V) is a pentavalent cation, and M(VI) is a hexavalent cation, 0≦x≦1.33]. The divalent cation (M(II)) and trivalent cation (M(III)) are mainly the cations used for substitution of the Li sites in the tunnel structure, and the pentavalent cation (M(V)) and hexavalent cation (M(VI)) are mainly used for substitution of the Sn sites forming an octahedron (SnO₆). The solid electrolyte represented by the above-described general formula is more preferably a lithium-tin substitution product satisfying 0<x≦1.33.

The substitution of the ramsdellite-type lithium tin oxide 100 with a different element can be achieved by at least one cation selected from the group consisting of divalent cation (M(II)), trivalent cation (M(III)), pentavalent cation (M(V)), and hexavalent cation (M(VI)). More specifically, the substitution with a different element may be carried out by any one of divalent cation (M(II)), trivalent cation (M(III)), pentavalent cation (M(V)), and hexavalent cation (M(VI)), or a plurality thereof. Accordingly, in the general formula, the coefficients a, b, c, and d each representing the molar ratio (substitution ratio) of the divalent cation (M(II)), trivalent cation (M(III)), pentavalent cation (M(V)), and hexavalent cation (M(VI)) satisfy 0<a+b+c+d, and any of them is greater than 0.

The solid electrolyte according to the present embodiment has, in particular, a chemical composition substituted with a different element in such a manner that the coefficients a, b, c, and d satisfy 3x−a−2b−c−2d≦2 in the above-described general formula. The meaning of the conditions for this composition is described below.

The composition formula of the ramsdellite-type lithium tin oxide (Li₄ₓSn₄₋ₓO₈) having excessive lithium ions can be represented by [Li₃ₓ□₄₋₃ₓ] [LiₓSn₄₋ₓ]O₈, in consideration of the empty site that is not filled with lithium ions. The □ represents the empty site that is not filled with lithium ions, among the Li sites where lithium ions can present in a metastable state in the tunnel structure. The [Li₃ₓ□₄₋₃ₓ] in the composition formula corresponds to the all Li sites existing in the tunnel structure.

Enlarging the composition formula in consideration of the empty site (□) to the above-described general formula, for example, when the substitution with a different element is carried out by a divalent cation (M(II)) alone, on the assumption that all the divalent cations (M(II)) are substituted with the Li sites in the tunnel structure, the formula can be represented as [Li₃ₓ₋ₐ□₄₋₃ₓ₊ₐ] [Liₓ₋ₐSn₄₋ₓM(II)ₐ]O₈. At this time, in order to avoid inhibition of lithium ion conduction by the substitution with a different element, the number of empty sites (□) is preferably greater than that of lithium ions. Accordingly, the molar ratio of lithium ions (3x−a) and that of the empty sites (□) (4−3x+a) preferably satisfies the relationship 3x−a≦4−3x+a, more specifically 3x−a≦2. In the same manner, when the substitution with a different element is carried out by a trivalent cation (M(III)) alone, the formula can be represented as [Li_{3x-2b}□_{4-3x+2b}] [Li_{x-b}Sn₄₋ₓM(III)_{b}]O₈, preferably 3x−2b≦2.

In addition, when the substitution with a different element is carried out by a pentavalent cation (M(V)) alone, on the assumption that all the pentavalent cations (M(V)) are substituted with Sn sites, the formula can be represented as [Li_{3x-c}□_{4-3x+c}] [LiₓSn_{4-x-c}M(V)_{c}]O₈, preferably 3x−c≦2. In the same manner, when the substitution with a different element is carried out by a hexavalent cation (M(VI)) alone, the formula can be represented as [Li_{3x-2d}□_{4-3x+2d}] [LiₓSn_{4-x-d}M(VI)_{d}]O₈, preferably 3x−2d≦2. Accordingly, when the substitution with a different element is carried out by a divalent cation (M(II)), a trivalent cation (M(III)), a pentavalent cation (M(V)), and a hexavalent cation (M(VI)), the formula can be represented as [Li_{3x-a-2b-c-2d}□_{4-3x+a+2b+c+2d}] [Li_{x-a-b}Sn_{4-x-c-d}]O₈, preferably 3x−a−2b−c−2d≦2.

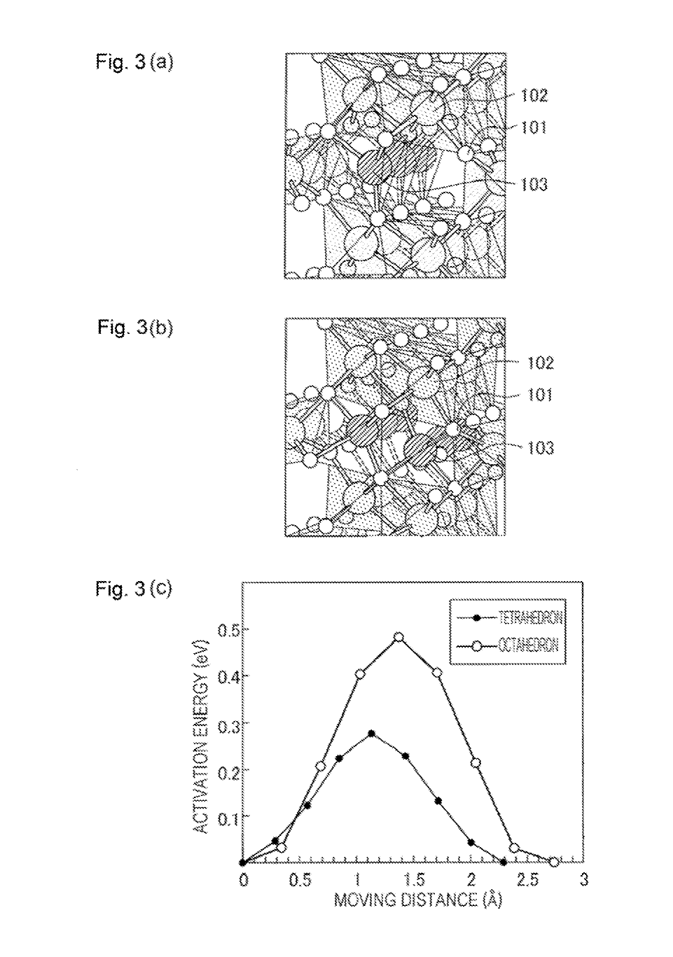

FIGS. 3(a) to 3(c) show the result of the analysis of lithium ion conductivity in the tunnel of a ramsdellite-type lithium tin oxide. The figure (a) shows the state of tetrahedron coordination of lithium ions in the tunnel in a ramsdellite-type crystal structure, the figure (b) shows the state of octahedron coordination of lithium ions in the tunnel in a ramsdellite-type crystal structure, and the figure (c) shows the comparison of lithium ion conductivity between the tetrahedron coordination and octahedron coordination states.

For a ramsdellite-type lithium tin oxide, the stable structure was simulatively analyzed based on the first principle calculation; when the 3x−a−2b−c−2d≦2 is satisfied, the tetrahedron coordination of the lithium ions 103 in the tunnel structure (see FIG. 3(a)) is stable, while when 3x−a−2b−c−2d>2, the octahedron coordination of the lithium ions 103 in the tunnel structure (see FIG. 3 (b)) is stable. In addition, for each state, conductivity of the lithium ions 103 in the tunnel structure was analyzed; it is presumed that as shown in FIG. 3(c), activation energy (activating energy Ea) (eV) caused by hopping of the lithium ions 103 takes a lower value when the lithium ions are in the state of tetrahedron coordination (• plot) than octahedron coordination (∘ plot) for generally all the cases having different movement distance (Å) of lithium ions.

Therefore, in the solid electrolyte according to the present embodiment, in the above-described general formula, the substitution with a different element is carried out in such a manner that the coefficients a, b, c, and d satisfy 3x−a−2b−c−2d≦2, thereby forming a metastable phase of lithium ions in the state of tetrahedron coordination, and causing charge repulsion by multivalent different element to reduce the activation energy of lithium ions, and thus achieving high lithium ion conductivity.

The solid electrolyte according to the present embodiment has a chemical composition substituted with a different element in such a manner that the coefficients a, b, c, and d satisfy 0≦a+b≦x, 0≦c+d<0.9 in the general formula. The reason why 0≦a+b≦x is as follows: if the substitution of the Li sites by the divalent cation (M(II)) and trivalent cation (M(III)) is excessive, the tunnel structure cannot be maintained, and lithium ion conductivity may be impaired. In addition, the divalent cation (M(II)) and trivalent cation (M(III)) invade into the tunnel structure, whereby lithium ion conduction may be hindered. The reason why 0≦c+d<0.9 is as follows: if the substitution of Sn sites by the pentavalent cation (M(V)) and hexavalent cation (M(VI)) is excessive, stable maintenance of the ramsdellite-type crystal structure becomes difficult. The more preferred form is the chemical composition that satisfies 0≦a+b≦x and 0≦a+b≦1.

The solid electrolyte according to the present embodiment is represented by a general formula Li₄ₓ₋₂ₐSn₄₋ₓM(II)ₐO₈ [wherein M(II) is a divalent cation, and satisfies 0≦x≦1.33], and satisfies 0<a≦x, and 3x−a≦2 in the above-described general formula when the substitution with a different element is achieved by a divalent cation (M(II)) alone. In this manner, in the solid electrolyte substituted with a different element by a divalent cation (M(II)) alone, the Li site is substituted only by the divalent cation (M(II)) having a relatively close ionic radius, whereby the crystal structure is stabilized, and mechanical durability is improved.

In addition, the solid electrolyte according to the present embodiment is represented by a general formula Li_{4x-3b}Sn₄₋ₓM(III)_{b}O₈ [wherein M (III) is a trivalent cation, and satisfies 0≦x≦1.33], and satisfies 0<b≦x, and 3x−2b≦2 in the above-described general formula when the substitution with a different element is achieved by a trivalent cation (M(III)) alone. In this manner, in the solid electrolyte substituted with a different element by a trivalent cation (M(III)) alone, the Li site is substituted only by the multivalent trivalent cation (M(III)), whereby the crystal structure is stabilized, and mechanical strength and cycle durability are effectively improved, even the substitution rate is lower. In addition, the crystal structure is stabilized at the low substitution rate, so that lithium ion conductivity is hard to be inhibited by the substitution.

In addition, the solid electrolyte according to the present embodiment is represented by a general formula Li_{4x-c}Sn_{4-x-c}M(V)_{c}O₈ [wherein M(V) is a pentavalent cation, and satisfies 0≦x≦1.33], and satisfies 0<c≦0.9, and 3x−c≦2 in the above-described general formula when the substitution with a different element is achieved by a pentavalent cation (M(V)) alone. In this manner, in the solid electrolyte substituted with a different element by a pentavalent cation (M(V)) alone, the Sn site is substituted only by the pentavalent cation (M(V)), whereby the activation energy of lithium ions can be reduced without markedly inhibiting lithium ion conductivity by the substitution.

In addition, the solid electrolyte according to the present embodiment is represented by a general formula Li_{4x-2d}Sn_{4-x-d}M(VI)_{d}O₈ [wherein M(VI) is a hexavalent cation, and satisfies 0≦x≦1.33], and satisfies 0<d≦0.9, and 3x−2d≦2 in the above-described general formula when the substitution with a different element is achieved by a hexavalent cation (M(VI)) alone. In this manner, in the solid electrolyte substituted with a different element by a hexavalent cation (M(VI)) alone, the Sn site is substituted only by the hexavalent cation (M(VI)), whereby the charge compensation is made even the substitutional rate is low, and activation energy for lithium ion conduction can be reduced without markedly inhibiting lithium ion conductivity by the substitution.

Specifically, the divalent cation (M(II)) used for the substitution with a different element is preferably at least one divalent cation selected from the group consisting of Be, Ca, Mg, Sr, Ba, and La. When the substitution is carried out by a plurality of divalent cations (M(II)), the above-described composition conditions must be satisfied with the total of the molar ratios as the coefficient a. Among them, the particularly preferred divalent cation (M(II)) is Mg. Mg has a close ionic radius to a lithium ion, and thus can reduce the activation energy for lithium ion conduction, while maintaining stability of the crystal structure.

Specifically, the trivalent cation (M(III)) used for the substitution with a different element is preferably at least one trivalent cation selected from the group consisting of Sc, Y, B, Al, Ga, and In. When the substitution is carried by a plurality of trivalent cations (M(III)), the above-described composition conditions must be satisfied, with the total of their molar ratios as the coefficient b. Among them, the particularly preferred trivalent cation (M(III)) is Al. Al is incorporated into the crystal structure while stability of the crystal structure is maintained, whereby activation energy for lithium ion conduction is reduced. In addition, Al is relatively low-cost, whereby the increase of the material cost due to substitution can be avoided.

Specifically, the pentavalent cation (M(V)) used for the substitution with a different element is preferably at least one pentavalent cation selected from the group consisting of V, Nb, Ta, P, As, Sb, and Bi. When the substitution is carried by a plurality of pentavalent cations (M(V)), the above-described composition conditions must be satisfied, with the total of their molar ratios as the coefficient c. Among them, the particularly preferred pentavalent cation (M(V)) is Nb or Ta. Nb and Ta have close ionic radiuses to tin ions, and scarcely change in their valence because they are electrochemically stable. Therefore, they reduce the activation energy for lithium ion conduction, with stability of the crystal structure maintained.

Specifically, the hexavalent cation (M(VI)) used for the substitution with a different element is preferably at least one hexavalent cation selected from the group consisting of Mo and W. When the substitution is carried by a plurality of hexavalent cations (M(VI)), the above-described composition conditions must be satisfied, with the total of their molar ratios as the coefficient d. Mo and W are electrochemically stable and scarcely change in the valence, and thus can reduce activation energy for lithium ion conduction, with stability of the crystal structure maintained.

The solid electrolyte according to the present embodiment is composed of the aggregate of particles of the ramsdellite-type lithium tin oxide substituted with a different element. When used in an all-solid-state battery, the particles of the solid electrolyte may be in the form of, for example, a compact formed by flocculation or sintering of particles. The shape of the compact of the solid electrolyte may be, for example, pellet or sheet. A pellet compact can be used as a solid electrolyte layer of a coin battery, and a sheet-like compact can be used as a solid electrolyte layer of a laminate battery, a square battery, or a cylindrical battery. The electric conductivity of lithium ions at room temperature is preferably 5.0×10⁻⁴ (Ω⁻¹·cm⁻¹) or more, and more preferably 1.0×10⁻³ (Ω⁻¹·cm⁻¹) or more.

In addition, the solid electrolyte according to the present embodiment may be in the form of a compact made by binding of particles by other oxide. Specific examples of the other oxide include an oxide sintering aid for improving the sintering properties of the particles of the solid electrolytes, and a glass sintering aid that has lithium ion conductivity and a lower glass transition temperature than the above-described solid electrolyte, and thus softens and flows to bind the particles at a lower temperature. When the particles of a solid electrolyte are fired or bound by any of these sintering aids, resistance between the particles of the solid electrolyte is reduced, and a compact having good lithium ion conductivity is obtained.

Examples of the oxide sintering aid include Al₂O₃, B₂O₃, and MgO. In addition, examples of the glass sintering aid include lithium borate (Li₃BO₃), a lithium borate-lithium carbonate solid solution represented by the general formula Li_{1-y}C_{y}B_{1-y}O₃ [wherein 0<y<1] lithium vanadate (LiVO₃), a NASICON type crystalline oxide represented by the general formula Li₁₊ₚAlₚTi₂₋ₚ(PO₄)₃, a NASICON type amorphous oxide represented by the general formula Li₁₊ₚAlₚTi₂₋ₚ(PO₄)₃, a NASICON type crystalline oxide represented by the general formula Li_{1+q}Ge_{q}Ti₂(PO₄)₃, and a NASICON type amorphous oxide represented by the general formula Li_{1+q}Ge_{q}Ti₂(PO₄)₃. The lithium borate and lithium borate-lithium carbonate solid solution are advantageous in that they are softened to flow at a relatively low temperature of about 700° C., and invade between the particles of a solid electrolyte to improve lithium ion conductivity. In addition, lithium vanadate is soluble in an aqueous solvent, and thus is advantageous in that the aqueous solvent can be removed at low temperature after mixing with a solid electrolyte. More specifically, these sintering aids can bind the particles of a solid electrolyte at low temperature, so that damage of the ramsdellite-type crystal structure by heat can be avoided.

In the next place, the method making a solid electrolyte according to the present embodiment is described.

The method for making a solid electrolyte according to the present embodiment is a method for making the above-described solid electrolyte by subjecting a ramsdellite-type lithium tin oxide to the substitution with a different element. More specifically, it relates to the method for making a ramsdellite-type lithium tin oxide represented by the general formula Li_{4x-2a-3b-c-2d}Sn_{4-x-c-d}M(II)ₐM(III)_{b}M(V)_{c}M(VI)_{d}O₈, and is composed of Li, Sn, and optionally a divalent cation (M(II)), a trivalent cation (M(III)), a pentavalent cation (M(V)), and a hexavalent cation (M(VI)). The making method shown below includes mainly a mixing step, a calcination step, a molding step, and a firing step.

In the mixing step, an Li-containing compound, an Sn-containing compound, and a compound optionally containing any of a divalent cation (M(II)), a trivalent cation (M(III)), a pentavalent cation (M(V)), or a hexavalent cation (M(VI) are mixed to prepare a powder. More specifically, in this step, the powder of an Li-containing compound, the powder of an Sn-containing compound, and the powder of a compound containing any of a divalent cation (M(II)), a trivalent cation (M(III)), a pentavalent cation (M(V)), or a hexavalent cation (M(VI)) at the ratio of the desired chemical composition of a solid electrolyte substituted with a different element, thereby preparing a mixed powder to be used as the material of a solid electrolyte. The lithium atom and tin atom may be lost by volatilization during firing, so that they may be added in an excessive amount of about 5% to 10% to the desired chemical composition of a solid electrolyte.

Preparation of the mixed powder may be carried out by dry mixing or wet mixing. Mixing of the powder may use, for example, various methods such as a planetary ball mill, a jet mill, an attritor, or a bead mill. The dispersion medium in wet mixing is preferably, for example, a lower alcohol such as ethanol. The mixing time may be an appropriate time, and is for example, from 30 minutes to 10 hours.

Examples of the Li-containing compound include lithium carbonate, lithium sulfate, lithium nitrate, lithium oxalate, lithium hydroxide, lithium acetate, and lithium chloride. Among them, the preferred Li-containing compound is lithium carbonate or lithium hydroxide. These compounds allow firing at a relatively low temperature.

Examples of the Sn-containing compound include tin oxide (IV), tin carbonate (IV), tin nitrate (IV), and tin chloride (IV). Among them, the preferred Sn-containing compound is tin oxide (IV). Since these compounds can be directly heated by microwave, they may be mixed with the mixed powder to be fired, thereby allowing firing of the solid electrolyte by heating with microwave irradiation.

Examples of the M element-containing compound containing a divalent cation (M(II)), a trivalent cation (M(III)), a pentavalent cation (M(V)), or a hexavalent cation (M(VI)) include carbonates, sulfates, nitrates, oxalates, hydroxides, and oxides. Among them, the preferred M element-containing compound is a carbonate or a hydroxide. These compounds can be burned at a relatively low temperature by gasification of the compound component.

In the calcination step, the prepared mixed powder is calcined. More specifically, in this step, the mixed powder is heat-treated before main firing, and a part of the components is oxidized while being desorbed by gasification. This calcination step is not essential, and may be abbreviated. The atmosphere for calcination is preferably an atmosphere or an oxygen-containing gas atmosphere. The heating for calcination may use an appropriate heating means such as an electric furnace, or a microwave irradiation heating apparatus, and preferably use a microwave irradiation heating apparatus. The microwave irradiation heating apparatus allow rapid heating, and rapid cooling by stopping irradiation. Therefore, it readily forms a ramsdellite structure by rapid cooling. However, this step does not certainly require the formation of a ramsdellite structure. The heating temperature in the calcination depends on the type of the raw material, and may be, for example, 700° C. or higher.

In the molding step, the fired mixed powder is molded under compression into the shape of the desired compact. When calcination is carried out, the calcined mixed powder is cracked, re-mixed, and then molded. This molding step is not essential, and may be abbreviated when molding is unnecessary. The molding of the mixed powder may be carried out, for example, cool or hot uniaxial pressure molding achieved by pressurization in one axial direction, cold isostatic pressing (CIP), or hot isostatic pressing (HIP) using a die. The mixed powder to be molded may be mixed with the Li-containing compound of the raw material again, thereby adjusting the proportion of the chemical components. In addition, the mixed powder to be molded may be subjected to particle sizing. The sizing of the particles of the mixed powder allows the homogenization of the chemical composition of the solid electrolyte to be made.

In the firing step, the mixed powder is fired by heating with microwave irradiation. When the powder is calcined, the calcined mixed powder is cracked, re-mixed, and then fired. When the powder is molded, the compact of the mixed powder is fired. In order to make a solid electrolyte having a ramsdellite-type crystal structure, heating treatment at a relatively high temperature and cooling treatment carried out by rapid cooling are necessary. In this firing step, heat treatment at a sufficient heating temperature using a microwave irradiation apparatus and rapid cooling by stopping of microwave irradiation allow the formation of a ramsdellite-type solid electrolyte.

Specifically, the heating temperature for firing is preferably 1000° C. or higher and 1300° C. or lower. The atmosphere for firing is preferably an atmosphere or an oxygen-containing gas atmosphere. The chemical components of the solid electrolyte may be vaporized during firing, so that the surrounding of the mixed powder to be fired may be covered by a calcined mixed powder during firing.

The properties of the solid electrolyte made through the above-described steps can be confirmed using any known analysis method. For example, the chemical composition can be confirmed by, for example, inductively-coupled plasma atomic emission spectrometry (ICP-AES), X-ray photoelectron spectroscopy (XPS), or X-ray fluorescence spectrometry (XRF). In addition, the crystal structure can be confirmed by, for example, X-ray diffractometry (XRD) or transmission electron microscopy with selected area electron diffraction (TEM-SAED)

Subsequently, the all-solid-state battery according to the present embodiment is described below.

The all-solid-state battery according to the present embodiment includes a positive electrode layer containing active materials for positive electrode, a negative electrode layer containing active materials for negative electrode, and a solid electrolyte layer sandwiched between the positive and negative electrode layers. This all-solid-state battery includes a solid electrolyte, which is a ramsdellite-type lithium tin oxide substituted with a different element, contained in at least one layer of the positive electrode layer, negative electrode layer, and solid electrolyte layer.

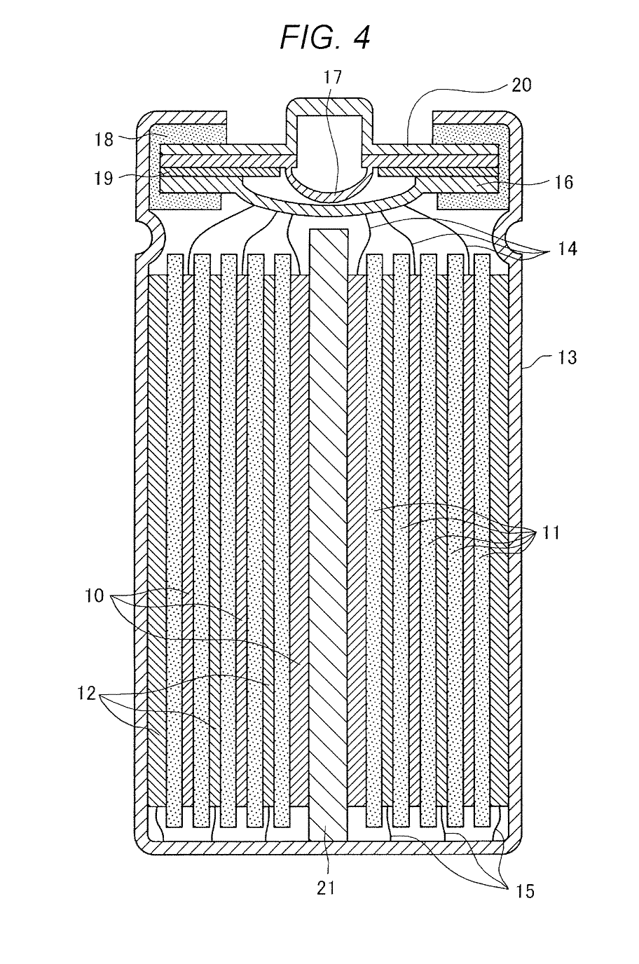

FIG. 4 is a cross sectional view showing one example of the all-solid-state battery according to one embodiment of the present invention.

As shown in FIG. 4, the all-solid-state battery includes a positive electrode layer 10, a solid electrolyte layer 11, a negative electrode layer 12, a battery can 13, a positive electrode current collection tab 14, a negative electrode current collection tab 15, an inner cap 16, an internal pressure release valve 17, a gasket 18, a positive temperature coefficient (PTC) resistive element 19, a battery cap 20, and a shaft center 21. The positive electrode layer 10, solid electrolyte layer 11, and negative electrode layer 12 are wound around the shaft center 21, and the positive electrode layer 10 is electrically connected to the inner cap 16 via the positive electrode current collection tab 14, and the negative electrode layer 12 is electrically connected to the battery can 13 via the negative electrode current collection tab 15. The opening of the top of the battery can 13 containing the positive electrode layer 10, solid electrolyte layer 11, and negative electrode layer 12 is hermetically sealed by the overlaid inner cap 16, internal pressure release valve 17, positive temperature coefficient resistive element 19, battery cap 20, and gasket 18.

The battery can 13, positive electrode current collection tab 14, and negative electrode current collection tab 15 are preferably made of a material having good corrosion resistance, and being resistant to deterioration by alloying with lithium ions. Specifically, the material is preferably, for example, aluminum, stainless steel, or nickel-plated steel. The all-solid-state battery shown in FIG. 4 is cylindrical, or may be, for example, compressed oval, compressed elliptical, square, or laminated.

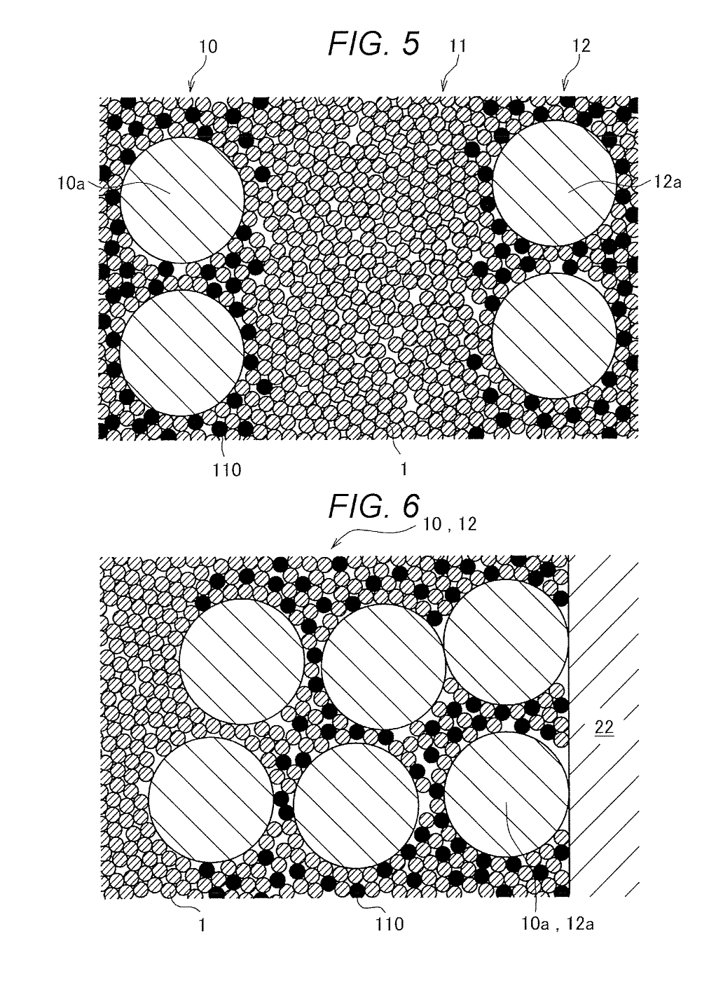

FIG. 5 is a cross sectional view schematically showing an example of the inter-electrode structure of the all-solid-state battery according to one embodiment of the present invention.

As shown in FIG. 5, the all-solid-state battery includes, as the inter-electrode structure, a positive electrode layer 10 containing active materials for positive electrode 10a, a negative electrode layer 12 containing active materials for negative electrode 12a, and a solid electrolyte layer 11 sandwiched between the positive electrode layer 10 and negative electrode layer 12. The solid electrolyte layer 11 is composed of the agglomeration of the particles of a solid electrolyte 1. In addition, the positive electrode layer 10 is composed of the particles of the active material for positive electrode 10a, particles of the solid electrolyte 1, and the particles of a conductive material 110. The negative electrode layer 12 is composed of the particles of the active material for negative electrode 12a, particles of the solid electrolyte 1, and the particles of the conductive material 110.

In the all-solid-state battery according to the present embodiment, the solid electrolyte 1, which is ramsdellite-type lithium tin oxide substituted with a different element, may be contained in the positive electrode layer 10 and negative electrode layer 12, and the solid electrolyte layer and positive electrode layer 10, and the solid electrolyte layer and negative electrode layer 12 may be bonded together in a bulk state via the solid electrolyte 1. This battery structure allows the reduction of the interfacial resistance in the electrode layers (10, 12) and solid electrolyte layer 11, and between the electrode layer (10,12) and solid electrolyte layer 11. In this all-solid-state battery, as shown in FIG. 5, a separator is not essential between the positive electrode layer 10 and negative electrode layer 12.

FIG. 6 is a cross sectional view schematically showing an example of the electrode structure of the all-solid-state battery according to one embodiment of the present invention.

As shown in FIG. 6, the electrode layers (10 and 12) included in the all-solid-state battery are formed so as to contact with a collector 22. This structure can be made by, for example, stacking the positive electrode layer 10 and negative electrode layer 12 on the both sides of the electrolyte layer 11, and pressure-bonding the collector 22 on the outside of the positive electrode layer 10 and the negative electrode layer 12, or stacking the positive electrode layer 10, solid electrolyte layer 11, and negative electrode layer 12 on the surface of the collector 22 in this order or in the reverse order. Alternatively, the green sheet method may be used. Under the green sheet method, the particles of the active materials (10a and 10b), conductive material 110, and solid electrolyte 1 are mixed with the binder resin to make a pasty electrode mixture, the electrode mixture is applied to the substrate and dried, and then the sheet-like electrode mixture thus obtained is fired, thereby sintering the particles and removing the binder resin. According to this green sheet method, a plurality of sheets of the electrode mixture may be stacked and fired to make an inter-electrode structure.

The active material for positive electrode 10a included in the all-solid-state battery may be a known and common active material for positive electrode that can occlude and discharge lithium ions. Specific examples of the active material for positive electrode include LiMO₂ (wherein M is an atom such as Ni, Co, or Mn), compounds prepared by substituting M of LiMO₂ with an atom such as Fe, Ti, Zr, Al, Mg, Cr, or V, spinel-type active materials for positive electrode represented by LiM₂O₄, olivine-type active materials for positive electrode such as LiFePO₄, layered solid solution active materials for positive electrode such as Li₂MnO₃—LiMO₂, silicate active materials for positive electrode such as Li₂MSiO₄, and vanadium active materials for positive electrode such as LiV₂(PO₄)₃ and LiV₃O₈—V₂O₃.

The active material for negative electrode 12a included in the all-solid-state battery may be a known and common active material for negative electrode that can occlude and discharge lithium ions. Specific examples of the active material for negative electrode include carbon materials such as graphite, alloy materials such as TiSn and TiSi, nitrides such as LiCoN, and oxides such as Li₄Ti₅O₁₂ and LiTiO₄. Alternatively, the battery may be composed of a lithium metal as the negative electrode.

The conductive material 110 included in the all-solid-state battery may be any appropriate material as long as it is chemically stable to battery reaction, and has good electron conductivity. Specific examples of the conductive material include carbon black such as ketjen black, acetylene black, furnace black, thermal black, and channel black, metal powders such as gold, silver, copper, nickel, aluminum, and titanium, Sb-doped SnOx, TiOx, and TiNx. The collector may be foil or a plate such as aluminum, stainless steel, copper, or nickel, according to the electrode.

In the all-solid-state battery having the above-described structure according to the present embodiment, the solid electrolyte 1 used in the electrode layers (10 and 12) or the solid electrolyte layer 11 has good lithium ion conductivity, so that the battery has low internal resistance. Therefore, an all-solid-state battery having good lithium ion conductivity, marked high rate characteristics, and being suitable to high output is provided.

### EXAMPLES

The present invention is specifically described below with reference to examples, but the technical scope of the present invention will not be limited to them.

Firstly, as the lithium tin oxides substituted with a different element, the solid electrolyte according to Examples 1 to 12 and the solid electrolytes according to Comparative Examples 1 to 8 were made, and their crystal structures were confirmed.

### Comparative Example 1

As Comparative Example 1, the ramsdellite-type solid electrolyte represented by Li_{3.2}Sn_{3.2}O₈ was made. In this solid electrolyte, x=0.8, a=b=c=d=0, and 3x−a−2b−c−2d=2.4.

The solid electrolyte according to Comparative Example 1 was made according to the following procedure. Firstly, 3.938 g of Li₂CO₃ and 16.062 g of SnO₂ were weighed, and subjected to wet mixing by ethanol for 30 minutes using an agate mortar. Subsequently, the ethanol was removed by drying at 80° C. to obtain a mixed powder. 10 g of the mixed powder thus obtained was charged into an alumina crucible, calcined at 800° C. for 6 hours to obtain a calcined powder. The calcined powder thus obtained was subjected to crystal analysis by XRD; it was confirmed that the main phase was composed of Li₂SnO₃ and SnO₂.

Subsequently, the calcined powder thus obtained was subjected to wet mixing again by ethanol, and the ethanol was removed by drying at 80° C. Subsequently, 0.5 g of the mixed powder thus obtained was charged into a pellet die having an inside diameter of 10 mm, subjected to uniaxial molding under a pressure of 250 MPa, thereby obtaining a temporal compact of solid electrolyte. Thereafter, an alumina foam was attached to the bottom of a quartz glass pipe having an inside diameter of 16 mm, and five pieces of temporal compacts were laminated in the quartz glass pipe. The laminate of the temporal compacts was surrounded by the mixed powder of the raw materials, thereby preventing volatilization of the chemical component during firing.

Subsequently, the quartz glass pipe filled with the temporal compacts was covered with a heat insulator, placed in a microwave irradiation apparatus, and fired by heating with microwave irradiation. In the heating with microwave irradiation, the surface temperature of the temporal compacts was increased to 1200° C., kept for 5 minutes, and then the microwave irradiation was stopped, and the object was rapidly cooled in an atmosphere. Thereafter, of the five pieces of the fired temporal compacts, central three pieces were collected so as to be used as the solid electrolyte according to Comparative Example 1.

The solid electrolyte according to Comparative Example 1 was pulverized and subjected to crystal analysis by XRD; a ramsdellite-type crystal structure was confirmed. In addition, the chemical components were determined by ICP-AES; the composition of Li_{3.2}Sn_{3.2}O₈ was confirmed.

### Example 1

As Example 1, a ramsdellite-type solid electrolyte represented by Li_{2.4}Sn_{3.2}Mg_{0.4}O₈ was made. In this solid electrolyte, x=0.8, a=0.4, b=c=d=0, and 3x−a−2b−c−2d=2.0.

The solid electrolyte according to Example 1 was made in the same manner as in Comparative Example 1, except that 3.938 g of Li₂CO₃, 16.062 g of SfO₂, and 0.55 g of MgCO₃ were weighed, mixed, and dried to obtain a mixed powder.

The solid electrolyte according to Example 1 was pulverized and subjected to crystal analysis by XRD; a ramsdellite-type crystal structure was confirmed. In addition, the chemical components were determined by ICP-AES; the composition of Li_{2.4}Sn_{3.2}Mg_{0.4}O₈ was confirmed.

### Example 2

As Example 2, a ramsdellite-type solid electrolyte represented by Li_{2.0}Sn_{3.2}Mg_{0.6}O₈ was made. In this solid electrolyte, x=0.8, a=0.6, b=c=d=0, and 3x−a−2b−c−2d=1.8.

The solid electrolyte according to Example 2 was made in the same manner as in Comparative Example 1, except that 1.21 g of Li₂CO₃, 7.95 g of SnO₂, and 0.84 g of MgCO₃ were weighed, mixed, and dried to obtain a mixed powder.

The solid electrolyte according to Example 2 was pulverized and subjected to crystal analysis by XRD; a ramsdellite-type crystal structure was confirmed. In addition, the chemical components were determined by ICP-AES; the composition of Li_{2.0}Sn_{3.2}Mg_{0.6}O₈ was confirmed.

### Example 3

As Example 3, a ramsdellite-type solid electrolyte represented by Li_{1.6}Sn_{3.2}Mg_{0.8}O₈ was made. In this solid electrolyte, x=0.8, a=0.8, b=c=d=0, and 3x−a−2b−c−2d=1.6.

The solid electrolyte according to Example 3 was made in the same manner as in Comparative Example 1, except that 0.97 g of Li₂CO₃, 7.92 g of SnO₂, and 1.10 g of MgCO₃ were weighed, mixed, and dried to obtain a mixed powder.

The solid electrolyte according to Example 3 was pulverized and subjected to crystal analysis by XRD; a ramsdellite-type crystal structure was confirmed, but a hetero-phase of MgO was partly found. In addition, the chemical components were determined by ICP-AES; the composition of Li_{1.6}Sn_{3.2}Mg_{0.8}O₈ was confirmed.

### Comparative Example 2

As Comparative Example 2, a ramsdellite-type solid electrolyte represented by Li_{2.6}Sn_{3.2}Mg_{0.3}O₈ was made. In this solid electrolyte, x=0.8, a=0.3, b=c=d=0, and 3x−a 2b−c−2d=2.1.

The solid electrolyte according to Comparative Example 2 was made in the same manner as in Comparative Example 1, except that 1.59 g of Li₂CO₃, 7.99 g of SnO₂, and 0.42 g of MgCO₃ were weighed, mixed, and dried to obtain a mixed powder.

The solid electrolyte according to Comparative Example 2 was pulverized and subjected to crystal analysis by XRD; a ramsdellite-type crystal structure was confirmed. In addition, the chemical components were determined by ICP-AES; the composition of Li_{2.6}Sn_{3.2}Mg_{0.3}O₈ was confirmed.

### Comparative Example 3

As Comparative Example 3, a ramsdellite-type solid electrolyte represented by Li_{1.4}Sn_{3.2}Mg_{0.9}O₈ was made. In this solid electrolyte, x=0.8, a=0.9, b=c=d=0, and 3x−a−2b−c−2d=1.5, wherein 0≦a+b≦x is not satisfied.

The solid electrolyte according to Comparative Example 3 was made in the same manner as in Comparative Example 1, except that 0.84 g of Li₂CO₃, 7.91 g of SnO₂, and 1.24 g of MgCO₃ were weighed, mixed, and dried to obtain a mixed powder.

The solid electrolyte according to Comparative Example 3 was pulverized and subjected to crystal analysis by XRD; a ramsdellite-type crystal structure was confirmed, but a hetero-phase of MgO was partly found. In addition, the chemical components were determined by ICP-AES; the composition of Li_{1.4}Sn_{3.2}Mg_{0.9}O₈ was confirmed.

### Example 4

As Example 4, a ramsdellite-type solid electrolyte represented by Li_{2.6}Sn_{3.2}Al_{0.2}O₈ was made. In this solid electrolyte, x=0.8, b=0.2, a=c=d=0, and 3x−a−2b−c−2d=2.0.

The solid electrolyte according to Example 4 was made in the same manner as in Comparative Example 1, except that 1.63 g of Li₂CO₃, 8.19 g of SnO₂, and 0.17 g of Al₂O₃ were weighed, mixed, and dried to obtain a mixed powder.

The solid electrolyte according to Example 4 was pulverized and subjected to crystal analysis by XRD; a ramsdellite-type crystal structure was confirmed, but hetero-phases of SnO₂ and Al₂O₃ were partly found. In addition, the chemical components were determined by ICP-AES; the composition of Li_{2.6}Sn_{3.2}Al_{0.2}O₈ was confirmed.

### Example 5

As Example 5, a ramsdellite-type solid electrolyte represented by Li_{2.0}Sn_{3.2}Al_{0.4}O₈ was made. In this solid electrolyte, x=0.8, b=0.4, a=c=d=0, and 3x−a−2b−c−2d=1.6.

The solid electrolyte according to Example 5 was made in the same manner as in Comparative Example 1, except that 1.28 g of Li₂CO₃, 8.36 g of SfO₂, and 0.35 g of Al₂O₃ were weighed, mixed, and dried to obtain a mixed powder.

The solid electrolyte according to Example 5 was pulverized and subjected to crystal analysis by XRD; a ramsdellite-type crystal structure was confirmed, but hetero-phases of SnO₂ and Al₂O₃ were partly found. In addition, the chemical components were determined by ICP-AES; the composition of Li_{2.0}Sn_{3.2}Al_{0.4}O₈ was confirmed.

### Example 6

As Example 6, a ramsdellite-type solid electrolyte represented by Li_{0.8}Sn_{3.2}Al_{0.8}O₈ was made. In this solid electrolyte, x=0.8, b=0.8, a=c=d=0, and 3x−a−2b−c−2d=0.8.

The solid electrolyte according to Example 6 was made in the same manner as in Comparative Example 1, except that 0.53 g of Li₂CO₃, 8.72 g of SnO₂, and 0.74 g of Al₂O₃ were weighed, mixed, and dried to obtain a mixed powder.

The solid electrolyte according to Example 6 was pulverized and subjected to crystal analysis by XRD; a ramsdellite-type crystal structure was confirmed, but hetero-phases of SnO₂ and Al₂O₃ were partly found. In addition, the chemical components were determined by ICP-AES; the composition of Li_{0.8}Sn_{3.2}Al_{0.8}O₈ was confirmed.

### Comparative Example 4

As Comparative Example 4, a ramsdellite-type solid electrolyte represented by Li_{2.9}Sn_{3.2}Al_{0.1}O₈ was made. In this solid electrolyte, x=0.8, b=0.1, a=c=d=0, and 3x−a−2b−c−2d=2.2.

The solid electrolyte according to Comparative Example 4 was made in the same manner as in Comparative Example 1, except that 1.80 g of Li₂CO₃, 8.11 g of SnO₂, and 0.09 g of Al₂O₃ were weighed, mixed, and dried to obtain a mixed powder.

The solid electrolyte according to Comparative Example 4 was pulverized and subjected to crystal analysis by XRD; a ramsdellite-type crystal structure was confirmed, but hetero-phases of SnO₂ and Al₂O₃ were partly found. In addition, the chemical components were determined by ICP-AES; the composition of Li_{2.9}Sn_{3.2}Al_{0.1}O₈ was confirmed.

### Comparative Example 5

As Comparative Example 5, a ramsdellite-type solid electrolyte represented by Li_{0.5}Sn_{3.2}Al_{0.9}O₈ was made. In this solid electrolyte, x=0.8, b=0.9, a=c=d=0, and 3x−a−2b−c−2d=0.6, wherein 0≦a+b≦x is not satisfied.

The solid electrolyte according to Comparative Example 5 was made in the same manner as in Comparative Example 1, except that 0.34 g of Li₂CO₃, 8.82 g of SnO₂, and 0.83 g of Al₂O₃ were weighed, mixed, and dried to obtain a mixed powder.

The solid electrolyte according to Comparative Example 5 was pulverized and subjected to crystal analysis by XRD; a ramsdellite-type crystal structure was confirmed, but hetero-phases of SnO₂ and Al₂O₃ were partly found. In addition, the chemical components were determined by ICP-AES; the composition of Li_{0.5}Sn_{3.2}Al_{0.9}O₈ was confirmed.

### Example 7

As Example 7, a ramsdellite-type solid electrolyte represented by Li_{2.8}Sn_{2.8}Nb_{0.4}O₈ was made. In this solid electrolyte, x=0.8, c=0.4, a=b=d=0, and 3x−a−2b−c−2d=2.0.

The solid electrolyte according to Example 7 was made in the same manner as in Comparative Example 1, except that 1.79 g of Li₂CO₃, 7.29 g of SnO₂, and 0.92 g of Nb₂O₅ were weighed, mixed, and dried to obtain a mixed powder.

The solid electrolyte according to Example 7 was pulverized and subjected to crystal analysis by XRD; a ramsdellite-type crystal structure was confirmed. In addition, the chemical components were determined by ICP-AES; the composition of Li_{2.8}Sn_{2.8}Nb_{0.4}O₈ was confirmed.

### Example 8

As Example 8, a ramsdellite-type solid electrolyte represented by Li_{2.6}Sn_{2.6}Nb_{0.6}O₈ was made. In this solid electrolyte, x=0.8, c=0.6, a=b=d=0, and 3x−a−2b−c−2d=1.8.

The solid electrolyte according to Example 8 was made in the same manner as in Comparative Example 1, except that 1.69 g of Li₂CO₃, 6.90 g of SnO₂, and 1.40 g of Nb₂O₅ were weighed, mixed, and dried to obtain a mixed powder.

The solid electrolyte according to Example 8 was pulverized and subjected to crystal analysis by XRD; a ramsdellite-type crystal structure was confirmed. In addition, the chemical components were determined by ICP-AES; the composition of Li_{2.6}Sn_{2.6}Nb_{0.6}O₈ was confirmed.

### Example 9

As Example 9, a ramsdellite-type solid electrolyte represented by Li_{2.4}Sn_{2.4}Nb_{0.8}O₈ was made. In this solid electrolyte, x=0.8, c=0.8, a=b=d=0, and 3x−a−2b−c−2d=1.6.

The solid electrolyte according to Example 9 was made in the same manner as in Comparative Example 1, except that 1.59 g of Li₂CO₃, 6.50 g of SnO₂, and 1.91 g of Nb₂O₅ were weighed, mixed, and dried to obtain a mixed powder.

The solid electrolyte according to Example 9 was pulverized and subjected to crystal analysis by XRD; a ramsdellite-type crystal structure was confirmed, but hetero-phases of SnO₂ and LiNbO₃ were partly found. In addition, the chemical components were determined by ICP-AES; the composition of Li_{2.4}Sn_{2.4}Nb_{0.8}O₈ was confirmed.

### Comparative Example 6

As Comparative Example 6, a ramsdellite-type solid electrolyte represented by Li_{2.9}Sn_{2.9}Nb_{0.3}O₈ was made. In this solid electrolyte, x=0.8, c=0.3, a=b=d=0, and 3x−a−2b−c−2d=2.1.

The solid electrolyte according to Comparative Example 6 was made in the same manner as in Comparative Example 1, except that 1.83 g of Li₂CO₃, 7.48 g of SnO₂, and 0.68 g of Nb₂O₅ were weighed, mixed, and dried to obtain a mixed powder.

The solid electrolyte according to Comparative Example 6 was pulverized and subjected to crystal analysis by XRD; a ramsdellite-type crystal structure was confirmed. In addition, the chemical components were determined by ICP-AES; the composition of Li_{2.9}Sn_{2.9}Nb_{0.3}O₈ was confirmed.

### Comparative Example 7

As Comparative Example 7, a ramsdellite-type solid electrolyte represented by Li_{2.3}Sn_{2.3}Nb_{0.9}O₈ was made. In this solid electrolyte, x=0.8, c=0.9, a=b=d=0, and 3x−a−2b−c−2d=1.5, wherein 0≦c+d<0.9 is not satisfied.

The solid electrolyte according to Comparative Example 7 was made in the same manner as in Comparative Example 1, except that 1.54 g of Li₂CO₃, 6.29 g of SnO₂, and 2.17 g of Nb₂O₅ were weighed, mixed, and dried to obtain a mixed powder.

The solid electrolyte according to Comparative Example 7 was pulverized and subjected to crystal analysis by XRD; a ramsdellite-type crystal structure was confirmed, but hetero-phases of SnO₂ and LiNbO₃ were partly found. In addition, the chemical components were determined by ICP-AES; the composition of Li_{2.3}Sn_{2.3}Nb_{0.9}O₈ was confirmed.

### Example 10

As Example 10, a ramsdellite-type solid electrolyte represented by Li_{2.6}Sn_{3.1}Mg_{0.1}Al_{0.1}Nb_{0.1}O₈ was made by heating with microwave irradiation. In this solid electrolyte, x=0.8, a=0.1, b=0.1, c=0.1, d=0, and 3x−a−2b−c−2d=2.0.

The solid electrolyte according to Example 10 was made in the same manner as in Comparative Example 1, except that 1.62 g of Li₂CO₃, 7.92 g of SnO₂, 0.14 g of MgCO₃, 0.086 g of Al₂O₃, and 0.23 g of Nb₂O₅ were weighed, mixed, and dried to obtain a mixed powder.

The solid electrolyte according to Example 10 was pulverized and subjected to crystal analysis by XRD; a ramsdellite-type crystal structure was confirmed. In addition, the chemical components were determined by ICP-AES; the composition of Li_{2.6}Sn_{3.1}Mg_{0.1}Al_{0.1}Nb_{0.1}O₈ was confirmed.

### Comparative Example 8

As Comparative Example 8, a solid electrolyte represented by Li_{2.6}Sn_{3.1}Mg_{0.1}Al_{0.1}Nb_{0.1}O₈ was made by heating with an electric furnace. In this solid electrolyte, x=0.8, a=0.1, b=0.1, c=0.1, d=0, and 3x−a−2b−c−2d=2.0.

The solid electrolyte according to Comparative Example 8 was made in the same manner as in Example 10, except that the calcined powder was fired by heating with an electric furnace. In the electric furnace, the temperature of the calcined powder was increased at a temperature rising rate of 1° C./minute, maintained at 1200° C. for 12 hours, and then decreased at a cooling rate of 1° C./minute.

The solid electrolyte according to Comparative Example 8 was pulverized and subjected to crystal analysis by XRD; no ramsdellite-type crystal structure was confirmed, and crystals of SnO₂, Li₂SnO₃, MgO, LiAlO₂, and LiNbO₃ were found.

### Example 11

As Example 11, a ramsdellite-type solid electrolyte represented by Li_{2.6}Sn_{3.1}Mg_{0.1}Al_{0.1}Nb_{0.1}O₈ was made without calcination. In this solid electrolyte, x=0.8, a=0.1, b=0.1, c=0.1, d=0, and 3x−a−2b−c−2d=2.0.

The solid electrolyte according to Example 11 was made in the same manner as in Example 10, except that the mixed powder obtained was subjected to uniaxial molding under pressure without calcination, thereby forming a temporal compact of a solid electrolyte.

The solid electrolyte according to Example 11 was pulverized and subjected to crystal analysis by XRD; a ramsdellite-type crystal structure was confirmed, but hetero-phases of SnO₂ and Li₂SnO₃ were partly found. In addition, the chemical components were determined by ICP-AES; the composition of Li_{2.6}Sn_{3.1}Mg_{0.1}Al_{0.1}Nb_{0.1}O₈ was confirmed.

### Example 12

As Example 12, a ramsdellite-type solid electrolyte represented by Li_{2.6}Sn_{3.1}Mg_{0.1}Al_{0.1}Nb_{0.1}O₈ was made using a sintering aid. The sintering aid was Li₃BO₃. In this solid electrolyte, x=0.8, a=0.1, b=0.1, c=0.1, d=0, and 3x−a−2b−c−2d=2.0.

The solid electrolyte according to Example 12 was made according to the following procedure. Firstly, a solid electrolyte obtained in the same manner as in Example 10 was cracked using an agate mortar, 0.49 g of the solid electrolyte powder thus obtained was mixed with 0.01 g of crystalline Li₃BO₃, and subjected to wet mixing with ethanol for 30 minutes. Subsequently, the ethanol was removed by heating at 80° C. to obtain a mixed powder.

Subsequently, the mixed powder thus obtained was charged into a pellet die having an inside diameter of 10 mm, subjected to uniaxial molding under a pressure of 250 MPa, thereby obtaining a temporal compact of solid electrolyte. Thereafter, the temporal compact thus obtained was charged into an alumina crucible together with the calcined powder of Example 10, and heat-treated at 700° C., which is the melting point of the sintering aid, for 1 hour, and the solid electrolyte according to Example 12 was collected.

The solid electrolyte according to Example 12 was pulverized, and subjected to crystal analysis by XRD; a ramsdellite-type crystal structure was confirmed. In addition, a cross section of the compact of the solid electrolyte was confirmed by a scanning electron microscope (SEM); it was confirmed that the compact thus obtained was composed of particles of a solid electrolyte densely bound together with few voids.

Subsequently, the solid electrolytes of Examples 1 to 12 and the solid electrolytes of Comparative Examples 1 to 8 thus made were subjected to the evaluation of lithium ion conductivity.

The lithium ion conductivity was evaluated based on the measurement of the ion electric conductivity by the alternating current impedance method. Au electrodes as blocking electrodes were formed on the both surfaces of the compacts of the solid electrolytes. The Au blocking electrodes were formed by sputtering in the thickness of 100 nm. In the glove box with an argon gas atmosphere, a collector was mounted on the blocking electrodes, and current voltage terminals were connected thereto, and the alternating current impedance was measured.

The alternating current impedance was measured with the ambient temperature changed in the range of 25° C. to 150° C. in a constant temperature bath. Thereafter, the measurement of the complex impedance was plotted, and the radius of the arc was calculated as the resistance value, based on the area of the electrodes and the thickness of the compact. In addition, an Arrhenius plot was made using the resistance value thus obtained, and the activation energy (activating energy Ea) caused by lithium ion conduction was calculated from the decline of the straight line. Table 1 shows the results of the electric conductivity (Ω⁻¹·cm⁻¹) of lithium ions and activating energy Ea (eV) at room temperature.

TABLE 1

| | | | Electric | Activating |
|---|---|---|---|---|
| | | | conductivity | energy Ea |
| | Composition | Firing method | (Ω⁻¹ · cm⁻¹) | (eV) |
| Comparative | Li_{3.2}Sn_{3.2}O₈ | Microwave | 6.7 × 10⁻⁷ | 0.49 |
| Example 1 | | | | |
| Example 1 | Li_{2.4}Sn_{3.2}Mg_{0.4}O₈ | Microwave | 1.5 × 10⁻³ | 0.28 |
| Example 2 | Li_{2.0}Sn_{3.2}Mg_{0.6}O₈ | Microwave | 1.2 × 10⁻³ | 0.28 |
| Example 3 | Li_{1.6}Sn_{3.2}Mg_{0.8}O₈ | Microwave | 8.1 × 10⁻⁴ | 0.30 |
| Comparative | Li_{2.6}Sn_{3.2}Mg_{0.3}O₈ | Microwave | 7.2 × 10⁻⁵ | 0.41 |
| Example 2 | | | | |
| Comparative | Li_{1.4}Sn_{3.2}Mg_{0.9}O₈ | Microwave | 1.0 × 10⁻⁴ | 0.32 |
| Example 3 | | | | |
| Example 4 | Li_{2.6}Sn_{3.2}Al_{0.2}O₈ | Microwave | 2.0 × 10⁻³ | 0.28 |
| Example 5 | Li_{2.0}Sn_{3.2}Al_{0.4}O₈ | Microwave | 1.8 × 10⁻³ | 0.29 |
| Example 6 | Li_{0.8}Sn_{3.2}Al_{0.8}O₈ | Microwave | 1.5 × 10⁻³ | 0.29 |
| Comparative | Li_{2.9}Sn_{3.2}Al_{0.1}O₈ | Microwave | 1.1 × 10⁻⁴ | 0.40 |
| Example 4 | | | | |
| Comparative | Li_{0.5}Sn_{3.2}Al_{0.9}O₈ | Microwave | 9.5 × 10⁻⁵ | 0.41 |
| Example 5 | | | | |
| Example 7 | Li_{2.8}Sn_{2.8}Nb_{0.4}O₈ | Microwave | 2.1 × 10⁻³ | 0.27 |
| Example 8 | Li_{2.6}Sn_{2.6}Nb_{0.6}O₈ | Microwave | 1.0 × 10⁻³ | 0.29 |
| Example 9 | Li_{2.4}Sn_{2.4}Nb_{0.8}O₈ | Microwave | 9.4 × 10⁻⁴ | 0.30 |
| Comparative | Li_{2.9}Sn_{2.9}Nb_{0.3}O₈ | Microwave | 1.0 × 10⁻⁴ | 0.40 |
| Example 6 | | | | |
| Comparative | Li_{2.3}Sn_{2.3}Nb_{0.9}O₈ | Microwave | 9.2 × 10⁻⁵ | 0.43 |
| Example 7 | | | | |
| Example 10 | Li_{2.6}Sn_{3.1}Mg_{0.1}Al_{0.1}Nb_{0.1}O₈ | Microwave | 2.0 × 10⁻³ | 0.27 |
| Comparative | SnO₂/Li₂SnO₃/MgO/LiAlO₂/LiNbO₃ | Electric | 1.0 × 10⁻¹⁰ | 0.79 |
| Example 8 | | furnace | | |
| Example 11 | Li_{2.6}Sn_{3.1}Mg_{0.1}Al_{0.1}Nb_{0.1}O₈ | Microwave | 1.0 × 10⁻³ | 0.29 |
| | | (without | | |
| | | calcination) | | |
| Example 12 | Li_{2.6}Sn_{3.1}Mg_{0.1}Al_{0.1}Nb_{0.1}O₈ | Microwave | 2.2 × 10⁻³ | 0.27 |
| | | (with | | |
| | | sintering | | |
| | | aid) | | |

As shown in Table 1, lithium ion conductivity higher than 1×10⁻³ (Ω⁻¹·cm⁻¹) is achieved in Examples 1 to 12 that satisfy the relationship 3x−a−2b−c−2d≦2, and it is confirmed that the lithium ion conductivity is about 1000 times higher than 6.7×10⁻⁷ (Ω⁻¹·cm⁻¹) of Comparative Example 1. In addition, in Examples 1 to 12, the activating energy Ea is about 0.30 eV or less, indicating that the activation energy is reduced just as the trial calculation based on the first principle calculation (see FIGS. 3(a) to 3(c)). On the other hand, in Comparative Examples 1, 2, 4, and 6 wherein the relationship 3x−a−2b−c−2d≦2 is not satisfied, substitution with Li and Sn sites is insufficient, so that the activation energy is not appropriately reduced, and lithium ion conductivity is poor. In Comparative Examples 3, 5, and 7, substitution with Li and Sn sites is excessive, so that lithium ion conductivity is deteriorated because of the destabilization of the crystal structure and inhibition of lithium ion conduction.

In addition, the comparison between Example 10, Comparative Example 8, Example 11, and Example 12 having the same chemical composition indicates that the formation of a ramsdellite-type crystal structure by rapid cooling is not found in Comparative Example 8 that was heated by an electric furnace, and that lithium ion conductivity is markedly impaired. On the other hand, activation energy is reduced in Examples 10, 11, and 12 that were heated by microwave irradiation, and lithium ion conductivity improved. In particular, the activation energy is rather lower and lithium ion conductivity is higher for Example 10 that was subjected to calcination, than Example 11 that was not subjected to calcination. The reason for this is considered that the formation of hetero-phases was suppressed in the solid electrolyte made through calcination, owing to the uniform crystal growth. In addition, the activation energy was further lower and lithium ion conductivity was higher in Example 12 that was fired using a sintering aid than Example 10. This result indicates that the use of a sintering aid allows making of a compact of a solid electrolyte by firing at a low temperature, and sufficiently reduces the interfacial resistance during bulk joining between the electrode layer and solid electrolyte layer.

Subsequently, all-solid-state batteries (all-solid-state batteries according to Example and Comparative Example) were made using the solid electrolytes according to Example 10 and Comparative Example 1, and the internal resistance was evaluated.

The all-solid-state battery according to Example was made using the powder of the solid electrolyte according to Example 10 having an average particle size of 0.8 μm as a solid electrolyte, LiCoO₂ having an average particle size of 12 μm as an active material for positive electrode, acetylene black as a conductive material, and lithium borate (Li₃BO₃) as a sintering aid.

Firstly, 60 parts by mass of the active material for positive electrode, 25 parts by mass of the solid electrolyte, 10 parts by mass of the conductive material, and 5 parts by mass of the sintering aid were mixed using a mortar. Subsequently, 30 parts by mass of an ethyl cellulose solution as a binding material was added to 70 parts by mass of the mixed powder thus obtained, and further mixed to obtain a positive electrode mixture in a slurry state.

Subsequently, the positive electrode mixture in a slurry state thus obtained was applied to one side of the compact of the solid electrolyte according to Example 10 (solid electrolyte layer having a thickness of 8 mm), and heat-treated at 400° C. for 30 minutes, and then 700 for 2 hours, thereby forming a positive electrode layer. The thickness of the positive electrode layer thus formed was 20 μm.

Subsequently, an Au collector having a film thickness of 200 nm was formed by sputtering on the positive electrode layer on the side opposed to the solid electrolyte layer thus obtained. Subsequently, Li foil was attached to the side opposed to the solid electrolyte layer of the positive electrode layer with a solid polyelectrolyte film (PEO skeleton, LiTFSI salt) sandwiched therebetween, and welded by heating, and thus obtaining an all-solid-state battery.

The all-solid-state battery according to Comparative Example was made in the same manner as the above-described all-solid-state battery according to Example, except that the solid electrolyte layer and positive electrode layer were formed using the solid electrolyte according to Comparative Example 1.

The internal resistance of the all-solid-state batteries according to Example and Comparative Example was measured using Potentiostat “1480” (Solartron). Specifically, the all-solid-state battery was charged at a constant current of 0.05 C with the upper limit voltage 4.3 V, and discharged until the state of charge (SOC) reached 50%, halted for 1 hour, and then the alternating current impedance was measured.

As a result of this, it was confirmed that the internal resistance of the all-solid-state battery according to the example was reduced half in comparison with the all-solid-state battery according to the comparative example. It is thus indicated that the use of the solid electrolyte of the present invention in the solid electrolyte layer or electrode layer allows the improvement of the internal resistance of the all-solid-state battery, and is effective at improving the rate characteristics.

### INDUSTRIAL APPLICABILITY

The solid electrolyte according to the present invention is useful as a battery material for all-solid-state lithium ion secondary batteries, and lithium-air batteries. In addition, it is also useful as a component of a censor including lithium ions as carrier.

### REFERENCE SIGNS LIST

100 ramsdellite-type lithium tin oxide
101 oxygen ion
102 tin ion
103 lithium ion
10 positive electrode layer
11 solid electrolyte layer
12 negative electrode layer
13 battery can
14 positive electrode current collection tab
15 negative electrode current collection tab
16 inner cap
17 internal pressure release valve
18 gasket
19 positive temperature coefficient resistive element
20 battery cap
21 shaft center

1. A solid electrolyte having a ramsdellite-type crystal structure, the solid electrolyte being represented by a general formula Li_{4x-2a-3b-c-2d}Sn_{4-x-c-d}M(II)ₐM(III)_{b}M(V)_{c}M(VI)_{d}O₈ [wherein M(II) is a divalent cation, M(III) is a trivalent cation, M(V) is a pentavalent cation, and M(VI) is a hexavalent cation, 0≦x≦1.33], wherein in the general formula, 0<a+b+c+d, 0≦a+b≦x, 0≦c+d<0.9, and 3x−a−2b−c−2d≦2.

2. The solid electrolyte of claim 1, wherein the M(II) is at least one divalent cation selected from the group consisting of Be, Ca, Mg, Sr, Ba, and La.

3. The solid electrolyte of claim 1, wherein the M(III) is at least one trivalent cation selected from the group consisting of Sc, Y, B, Al, Ga, and In.

4. The solid electrolyte of claim 1, wherein the M(V) is at least one pentavalent cation selected from the group consisting of V, Nb, Ta, P, As, Sb, and Bi.

5. The solid electrolyte of claim 1, wherein the M(VI) is at least one hexavalent cation selected from the group consisting of Mo and W.

6. The solid electrolyte of claim 1, wherein b=c=d=0, the solid electrolyte being represented by a general formula Li₄ₓ₋₂ₐSn₄₋ₓM(II)ₐO₈ [wherein M(II) is a divalent cation, 0≦x≦1.33], wherein in the general formula, 0<a≦x, and 3x−a≦2.

7. The solid electrolyte of claim 1, wherein a=c=d=0, the solid electrolyte being represented by a general formula Li_{4x-3b}Sn₄₋ₓM(III)_{b}O₈ [wherein M(III) is a trivalent cation, 0≦x≦1.33], wherein in the general formula, 0<b≦x, and 3x−2b≦2.

8. The solid electrolyte of claim 1, wherein a=b=d=0, the solid electrolyte being represented by a general formula Li_{4x-c}Sn_{4-x-c}M(V)_{c}O₈ [wherein M(V) is a pentavalent cation, 0≦x≦1.33], wherein in the general formula, 0<c≦0.9, and 3x−c≦2.

9. The solid electrolyte of claim 1, wherein a=b=c=0, the solid electrolyte being represented by a general formula Li_{4x-2d}Sn_{4-x-d}M(VI)_{d}O₈ [wherein M(VI) is a hexavalent cation, 0≦x≦1.33], wherein in the general formula, 0<d≦0.9, and 3x−2d≦2.

10. An all-solid-state battery comprising the solid electrolyte of claim 1, wherein the solid electrolyte is contained in at least one layer of a positive electrode layer containing an active material for positive electrode, a negative electrode layer containing an active material for negative electrode, and a solid electrolyte layer sandwiched between the positive and negative electrode layers.

11. An all-solid-state battery comprising the solid electrolyte of claim 1, and an oxide having lithium ion conductivity and a lower glass transition temperature than the solid electrolyte, wherein a compact formed by binding the solid electrolyte with the oxide is contained in at least one layer of a positive electrode layer containing an active material for positive electrode, a negative electrode layer containing an active material for negative electrode, and a solid electrolyte layer sandwiched between the positive and negative electrode layers.

12. The all-solid-state battery of claim 11, wherein the oxide is at least one oxide selected from the group consisting of lithium borate (Li₃BO₃), a lithium borate-lithium carbonate solid solution represented by a general formula Li_{1-y}C_{y}B_{1-y}O₃ [wherein 0<y<1], lithium vanadate (LiVO₃), a NASICON type crystalline oxide represented by a general formula Li₁₊ₚAlₚTi₂₋ₚ(PO₄)₃, a NASICON type amorphous oxide represented by a general formula, a NASICON type crystalline oxide represented by a general formula Li_{1+q}Ge_{q}Ti₂(PO₄)₃, and a NASICON type amorphous oxide represented by a general formula.

13. A method for making a solid electrolyte that has a ramsdellite-type crystal structure, and is represented by a general formula Li_{4x-2a-3b-c-2d}Sn_{4-x-c-d}M(II)ₐM(III)_{b}M(V)_{c}M(VI)_{d}O₈ [wherein M(II) is a divalent cation, M(III) is a trivalent cation, M(V) is a pentavalent cation, M(VI) is a hexavalent cation, 0≦x≦1.33],
wherein in the general formula, 0<a+b+c+d, 0≦a+b≦x, 0≦c+d<0.9, and, 3x−a−2b−c−2d≦2, and
the method for making a solid electrolyte comprising a step of mixing an Li-containing compound, an Sn-containing compound, a compound optionally containing any of M(II), M(III), M(V), or M(VI) to prepare a mixed powder, and a step of firing the mixed powder thus prepared by heating with microwave irradiation.

14. The method for making a solid electrolyte of claim 13, further comprising a step of press-molding the mixed powder thus prepared, wherein the press-molded mixed powder is fired by heating with microwave irradiation.

15. The method for making a solid electrolyte of claim 14, further comprising a step of calcining the mixed powder thus prepared, wherein the calcined mixed powder is cracked and press-molded, and fired by heating with microwave irradiation.

16. The method for making a solid electrolyte of claim 13, wherein the Li-containing compound is lithium carbonate.

17. The method for making a solid electrolyte of claim 13, wherein the Sn-containing compound is tin oxide.
